(19) United States
(12) Patent Application Publication
(10) Pub. No.: US 2012/0230559 A1
(43) Pub. Date: Sep. 13, 2012

(54) IMAGE PROCESSING APPARATUS, IMAGE PROCESSING METHOD, AND IMAGE PROCESSING PROGRAM

(75) Inventor: Yoshinori ITAI, Minato-ku (JP)

(73) Assignee: FUJIFILM CORPORATION, Tokyo (JP)

(21) Appl. No.: 13/415,122

(22) Filed: Mar. 8, 2012

(30) Foreign Application Priority Data
Mar. 9, 2011 (JP) 2011-050960

(51) Int. Cl. G06K 9/00

(52) U.S. Cl. 382/128

(57) ABSTRACT

When an obstruction to observation is specified within one of a plurality of examination images, specification of a portion corresponding to the portion of the obstruction to observation within a different examination image is facilitated. An obstruction to observation is specified in a first examination image, from among a plurality of examination images that represent the interior of a subject having a lumen imaged by a medical image obtaining apparatus. A portion is specified within a second examination image, from among the plurality of examination images in which the obstruction to observation has not been specified, corresponding to the obstruction to observation specified within the first examination image. A plurality of observation images that visualize of the interior of the lumen are generated from the plurality of examination images. The portion corresponding to the specified obstruction to observation is indicated within an observation image generated from the second examination image.

### BACKGROUND OF THE INVENTION

1. Field of the Invention

The present invention is related to an image processing apparatus, an image processing method, and an image processing program. More specifically, the present invention is related to an image processing apparatus, an image processing method, and an image processing program for generating observation images that visualize lumen portions within the bodies of subjects, from examination image data that represent the interiors of the subjects.

2. Description of the Related Art

Three dimensional images having high image quality are able to be generated, accompanying recent advances in imaging apparatuses (modalities) such as MDCT (Multi Detector row Computed Tomography). A virtual endoscopy image display method has been proposed as an application of a three dimensional image display technology. The virtual endoscopy image display method is a technique that generates images that approximate endoscopy images obtained by imaging the interiors of lumen tissue (hereinafter, also referred to as “virtual endoscopy images”), from a plurality of two dimensional CT tomographic images obtained by CT imaging, for example.

The virtual endoscopy image display method may be employed in CT examinations of the large intestine, for example. Advantages of CT examinations of the large intestine employing the virtual endoscopy image display method are that such examinations are less invasive than normal endoscopy examinations, that the states of the interiors of lumens beyond occlusions can be displayed, etc. A great number of evaluations of polyp detection performance by virtual endoscopy image display, and results of clinical trials of comparisons between polyp detection performance employing CT examinations and endoscopic examinations of the large intestine has have been reported, and the effectiveness of CT examinations of the large intestine utilizing the virtual endoscopy image display method has been indicated thereby. In the future, it is expected that CT examinations of the large intestine will be performed not only for pre operation examinations, but also for screenings.

CT examinations of the large intestine require a preliminary process with a laxative, to remove the contents of the large intestine. If the preliminary process is incomplete, observation of polyps will become difficult. That is, the surfaces of the large intestine are visualized in a virtual endoscopy image, and therefore if a polyp is completely buried under residue, only the surface of the residue will be imaged in the virtual endoscopy image. In addition, distinction between polyps and residue within tomographic images will also become difficult in the case that the CT values of polyps and the CT values of residue are approximately the same.

In order to solve the aforementioned problems associated with CT examinations of the large intestine, supine/prone imaging and the fecal tagging method have been proposed. In supine/prone imaging, a subject is imaged in both the supine and prone positions. Images obtained by imaging in the supine and prone positions are observed to distinguish residue and polyps, utilizing movement of residue due to the change in the position of the subject's body. Meanwhile, the fecal tagging method is a technique that increases (tags) the CT value of residue by a contrast agent which is orally administered in advance. By increasing the contrast of the residue, the CT values of the residue and polyps will become different, and distinction between the two is facilitated. In addition, a method that employs image processes to remove residue regions of which the contrast has been increased (the digital cleansing method) has also been proposed (U.S. Pat. No. 6,331,116).

A technique for simultaneously displaying two virtual endoscopy images has been proposed as an effective method for observing CT images obtained by supine/prone imaging (U.S. Pat. No. 5,891,030). The invention of U.S. Pat. No. 5,891,030 generates a virtual endoscopy image having a desired viewpoint from one of two sets of examination images (supine CT images and prone CT images). Then, a virtual endoscopy image having a point that corresponds to the viewpoint set within the one set of examination images as a viewpoint is generated from the other of the two sets of examination images. The two generated images are displayed simultaneously on a display screen. This configuration enables users to easily compare the states of the same position within the two sets of examination images.

By utilizing the technique disclosed in Japanese Patent No. 4088348, users can expediently confirm changes in obstructions to observation, such as movement of residue and changes in the degree of overlap of folds in a second examination image, when obstructions to observation such as residue regions, occlusions, and overlapping folds are confirmed in a first examination image. Such expedient confirmation leads to expectations of improvements in diagnostic efficiency. However, in the case that two simultaneously displayed virtual endoscopy images are observed, it is not easy to quickly judge how an obstruction to observation within one virtual endoscopy image is displayed in the other virtual endoscopy image. In addition, it is also difficult to judge whether an obstruction to observation within one virtual endoscopy image is present in the other virtual endoscopy image. Therefore, there is a problem that the time required for users to confirm changes to obstructions to observation becomes long.

### SUMMARY OF THE INVENTION

The present invention has been developed in view of the foregoing circumstances. It is an object of the present invention to provide an image processing apparatus, an image processing method, and an image processing program that enables easy discrimination of a portion within examination images corresponding to a portion at which an obstruction to observation is specified within another examination image.

To achieve the above object, the present invention provides an image processing apparatus, comprising:

an observation obstruction specifying section that specifies an obstruction to observation in a first examination image, from among a plurality of examination images that represent the interior of a subject having a lumen imaged by a medical image obtaining apparatus;

a corresponding position determining section that specifies a portion within a second examination image, from among the plurality of examination images in which the obstruction to observation has not been specified, corresponding to the obstruction to observation specified within the first examination image;

an observation image generating section that generates a plurality of observation images that enable visualization of the interior of the lumen, from the plurality of examination images; and

a corresponding position indicating section that indicates the portion corresponding to the obstruction to observation specified by the corresponding position determining section within an observation image generated from the second examination image.

Here, examples of the obstruction to observation may be locations at which residue is present in CT examination of the large intestine, locations at which intestinal tracts are bent, such as the hepatic flexure and the splenic flexure, and locations where intestinal tracts are occluded. Specification of the obstruction to observation may be performed automatically by the observation obstruction specifying section based on the first examination image. Alternatively, a user may be prompted to input the location of an obstruction to observation, and the location input by the user may be specified as the obstruction to observation. The obstruction to observation specified by the observation obstruction specifying section is not limited to locations that actually obstruct observation within an observation image that visualizes the first examination image, and may be a location that the user wishes to carefully observe within an examination image other than the examination image in which the obstruction to observation is specified. Indication of the portion that corresponds to the obstruction to observation may be performed by enhanced contrast, an annotation, or display of a warning.

A configuration may be adopted, wherein:

the observation obstruction specifying section specifies one of a desired pixel and a region having a desired range within a region corresponding to the lumen in the first examination image as the portion of the obstruction to observation.

The image processing apparatus of the present invention may further comprise:

a positional aligning section that generates correspondent relationships among pixels of the regions within at least the first and the second examination images that correspond to the lumen; and wherein:

the corresponding position determining section employs the generated correspondent relationships to specify one of the position and the region in the second examination image that corresponds to one of the position and the region specified in the first examination image as the portion that corresponds to the obstruction to observation.

The positional aligning section may perform non rigid registration between the regions corresponding to the lumen in the first and second examination images, and may generate the correspondent relationships based on the results of the positional alignment.

A configuration may be adopted, wherein:

the observation image generating section generates a virtual endoscopy image that enables visualization of the interior of the lumen as a pseudo three dimensional image as the observation image;

the corresponding position indicating section indicates the portion corresponding to the specified obstruction to observation when the specified position or region in the second examination image is visualized in a virtual endoscopy image generated from the second examination image.

Alternatively, a configuration may be adopted, wherein:

the observation image generating section generates at least one of an expanded view image, in which the lumen is extended linearly, a portion corresponding to the inner wall of the lumen is cut open and projected two dimensionally, and a straight view image, in which the lumen is cut at a predetermined plane and the lumen is viewed from a direction perpendicular to the plane, as an observation image; and

the corresponding position indicating section indicates the portion within the observation image corresponding to the position or region specified in the second examination image as the specified obstruction to observation.

The image processing apparatus of the present invention may further comprise:

a path setting section that sets paths within the lumen in each of the first and second examination images; wherein:

the observation obstruction specifying section specifies a desired position along the path set within the lumen in the first examination image as the portion of the obstruction to observation; and

the corresponding position determining section determines a position along the path set within the lumen in the second examination image corresponding to a position along the path set within the lumen in the first examination image as the portion corresponding to the obstruction to observation, based on the correspondent relationship between the paths set within lumens in the first and second examination images.

A configuration may be adopted, wherein:

the observation image generating section generates a virtual endoscopy image having a desired point along the set path as a viewpoint as the observation image; and

the corresponding position indicating section indicates a portion within the virtual endoscopy image corresponding to the specified obstruction to observation, when a virtual endoscopy image having a position specified as the portion corresponding to the obstruction to observation along the path set within the lumen in the second examination image as a viewpoint.

As an alternative or in addition to the above, a configuration may be adopted, wherein:

the observation image generating section generates at least one of an expanded view image, in which the lumen is extended linearly, a portion corresponding to the inner wall of the lumen is cut open and projected two dimensionally, and a straight view image, in which the lumen is cut at a predetermined plane and the lumen is viewed from a direction perpendicular to the plane, as an observation image; and

the corresponding position indicating section indicates the portion within the observation image at the position specified along the path set in the lumen within the second examination image as the portion corresponding to the specified obstruction to observation.

The present invention also provides an image processing method, comprising the steps of:

specifying an obstruction to observation in a first examination image, from among a plurality of examination images that represent the interior of a subject having a lumen imaged by a medical image obtaining apparatus;

specifying a portion within a second examination image, from among the plurality of examination images in which the obstruction to observation has not been specified, corresponding to the obstruction to observation specified within the first examination image;

generating a plurality of observation images that enable visualization of the interior of the lumen, from the plurality of examination images; and

indicating the portion corresponding to the specified obstruction to observation within an observation image generated from the second examination image.

The present invention further provides a program that causes a computer to execute the procedures of:

specifying an obstruction to observation in a first examination image, from among a plurality of examination images that represent the interior of a subject having a lumen imaged by a medical image obtaining apparatus;

specifying a portion within a second examination image, from among the plurality of examination images in which the obstruction to observation has not been specified, corresponding to the obstruction to observation specified within the first examination image;

generating a plurality of observation images that enable visualization of the interior of the lumen, from the plurality of examination images; and

indicating the portion corresponding to the specified obstruction to observation within an observation image generated from the second examination image.

The image processing apparatus, the image processing method, and the image processing program specifies an obstruction to observation within one of a plurality of examination images, specifies portions within other examination images, in which the obstruction to observation has not been specified, corresponding to the specified obstruction to observation, and indicates the specified portions within observation images generated from the examination images in which the obstruction to observation has not been specified. This configuration enables portions corresponding to a specified obstruction to observation within examination images other than the examination image in which the obstruction to observation is specified, when the obstruction to observation is specified in one of a plurality of examination images.

### BRIEF DESCRIPTION OF THE DRAWINGS

FIG. 1 is a block diagram that illustrates an image processing apparatus according to a first embodiment of the present invention.

FIG. 2A and FIG. 2B are diagrams that illustrate examples of large intestine regions extracted from a first examination image and a second examination image.

FIG. 3 is a diagram that illustrates an example of a virtual endoscopy image in which residue is visualized.

FIG. 4 is a diagram that illustrates an example of a virtual endoscopy image in which folds are concentrated on an inner wall.

FIG. 5 is a diagram that illustrates a case in which an occlusion is present in an intestinal tract.

FIG. 6A, FIG. 6B, and FIG. 6C are diagrams that illustrate examples of methods by which portions corresponding to obstructions to observation are indicated.

FIG. 7 is a flow chart that illustrates the operating procedures of the image processing apparatus of FIG. 1.

FIG. 8 is a diagram that illustrates an example of an expanded view image.

FIG. 9 is a diagram that illustrates an example of a straight view image.

FIG. 10 is a block diagram that illustrates an image processing apparatus according to a second embodiment of the present invention.

FIG. 11A and FIG. 11B are diagrams that illustrate a large intestine region within a first examination image and a second examination image.

### DESCRIPTION OF THE PREFERRED EMBODIMENTS

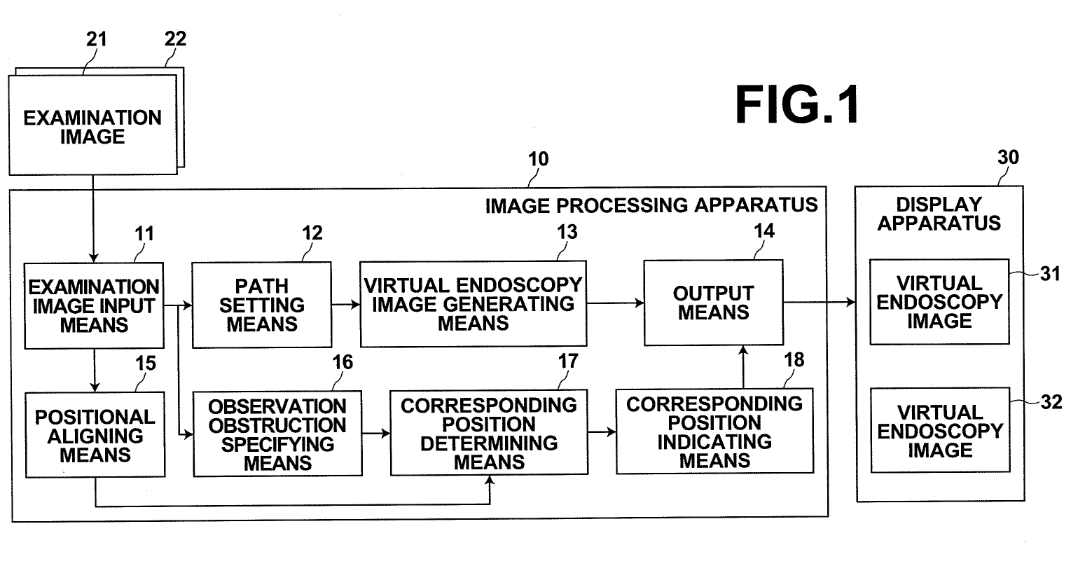

Hereinafter, embodiments of the present invention will be described in detail with reference to the attached drawings. FIG. 1 illustrates an image processing apparatus 10 according to a first embodiment of the present invention. The image processing apparatus 10 is equipped with: an examination image input means 11; a path setting means 12; a virtual endoscopy image generating means 13; an output means 14; a positional aligning means 15; an observation obstruction specifying means 16; a corresponding position determining means 17; and a corresponding position indicating means 18. The image processing apparatus 10 is constituted by a computer system such as a server or a work station. The functions of each component of the image processing apparatus 10 can be realized by the computer system executing processes according to a predetermined program.

The examination image input means 11 inputs a first examination image 21 (examination image data) and a second examination image 22 (examination image data). Each of the first and second examination images 21 and 22 is three dimensional image data that represents the interior of a subject having lumens, obtained by a medical imaging apparatus. The imaging apparatus employed to obtain the first and second examination images 21 and 22 is an X ray CT apparatus, for example. The first and second examination images 21 and 22 are, for example, image data in which tomographic images of the subject obtained at a predetermined slice thickness are layered.

The first examination image 21 and the second examination image 22 are different sets of image data obtained by imaging a single subject. In other words, the first examination image 21 and the second examination image 22 are not the same data. The first examination image 21 and the second examination image 22 are, for example, data obtained by imaging a single person in different bodily positions. For example, the first examination image 21 is data obtained by imaging with the person in the supine position, and the second examination image 22 is data obtained by imaging with the person in the prone position. The combination of the first examination image 21 and the second examination image 22 is not limited to this, and various combinations may be considered. For example, an image obtained by imaging a subject in the past may be designated as the first examination image 21, and an image obtained by a current imaging operation may be designated as the second examination image 22.

The path setting means sets paths within the interiors of lumens within the first examination image 21 and the second examination image 22. The path setting means 21 sets a first path along the lumen pictured in the first examination image 21. In addition, the path setting means 21 sets a second path along the lumen pictured in the second examination image 22. In the case that the lumen is a large intestine, for example, the path setting means 12 sets paths having the exit of the large intestine (the anus) as a starting point and the boundary with the small intestine as the endpoint as the first and second paths.

The paths set by the path setting means 12 are determined based on the shape (structure) of the lumen. For example, the path setting means 12 may extract lumen regions by analyzing the first and second examination images 21 and 22, and automatically set the first and second paths based on the structures of the extracted lumen regions. Alternatively, the path setting means 12 may designate paths set by a user as desired while referring to the three dimensional images of the lumens displayed on a display apparatus 30 as the first and second paths. As a further alternative, the path setting means 12 may designate automatically set paths which are corrected by a user as the first and second paths.

The virtual endoscopy image generating means 13 is an observation image generating means for generating observation images that visualize the interiors of the lumens. The virtual endoscopy image generating means 13 generates virtual endoscopy images that pseudo three dimensionally visualize the interior of the lumen within the subject's body as observation images. The virtual endoscopy image generating means 13 generates a first virtual endoscopy image and a second virtual endoscopy image based on the first and second examination images 21 and 22, respectively. The lumen which is visualized by the first virtual endoscopy image and the lumen which is visualized by the second virtual endoscopy image are the same lumen. The virtual endoscopy image generating means 13 generates a first virtual endoscopy image that visualizes the interior of a large intestine pictured in the first examination image 21, and generates a second virtual endoscopy image that visualizes the interior of a large intestine pictured in the second examination image 22, for example.

The virtual endoscopy image generating means 13 places viewpoints along the paths set by the path setting means 12, and generates images that simulate views of the interior of the lumen from the viewpoints as virtual endoscopy images. For example, the virtual endoscopy image generating means 13 may generate virtual endoscopy images while sequentially changing viewpoints along the paths from the starting points to the endpoints thereof. The virtual endoscopy image generating means 13 may generate first and second virtual endoscopy images having points equidistant from the starting points of the first path and the second path. It is not necessary for the viewpoints of the virtual endoscopy images to be along the paths set by the path setting means 12. The virtual endoscopy image generating means 13 may generate virtual endoscopy images having points set by a user as desired as the viewpoints thereof.

The output means 14 outputs the virtual endoscopy images generated by the virtual endoscopy image generating means 13 to the display apparatus 30. The display apparatus 30 is a display device such as a liquid crystal display, for example. The display apparatus 30 display the first virtual endoscopy image 31 and the second virtual endoscopy image 32 on a display screen. The output means 14 may simultaneously output the first and second virtual endoscopy images and cause the first and second virtual endoscopy images 31 and 32 to be displayed simultaneously on the display screen of the display apparatus. Alternatively, the output means 14 may selectively output the first and second virtual endoscopy images, and switch between display of the first and second virtual endoscopy images 31 and 32 on the display screen of the display apparatus 30.

The positional aligning means 15 generates correspondent relationships among pixels of at least the regions within the first and the second examination images 21 and 22 that correspond to the lumen. The positional aligning means 15 performs positional alignment with respect to the first and second examination images 21 and 22, and correlates the pixels of the two images with each other. The positional aligning means 15 may correlate the entireties of the image data of the first and second examination images 21 and 22 in pixel units. Alternatively, the positional aligning means 15 may extract regions from the first and second examination images 21 that constitute the lumens, and the extracted lumen regions may be correlated in pixel units.

The observation obstruction specifying means 16 specifies an obstruction to observation in one of the first and second examination images 21 and 22. Hereinafter, mainly cases in which an obstruction to observation is specified within the first examination image 21 will be described. Examples of obstructions to observation include: residue within the large intestine; the hepatic flexure; the splenic flexure; and occlusions. Specification of the obstruction to observation may be performed automatically by the observation obstruction specifying means 16 based on the first examination image 21. Alternatively, a user may manually specify the obstruction to observation. In the case that the obstruction to observation is manually specified, specifications of the obstruction to observation may be input while a virtual endoscopy image generated from the first examination image 21 is being displayed by the display apparatus 30. The observation obstruction specifying means 16 specifies the position of a desired pixel or a region having a desired range within a region corresponding to the lumen in the first examination image 21 as the portion of the obstruction to observation.

It is not necessary for the obstruction to observation specified within the first examination image 21 to be an actual obstruction to observation when the first examination image 21 is visualized and displayed. For example, a portion within the first examination image 21, the state of which is desired to be confirmed within the second examination image 22, may be specified as an obstruction to observation.

The corresponding position determining means 17 specifies a portion within the other of the first and second examination images 21 and 22, in which the obstruction to observation has not been specified, corresponding to the obstruction to observation specified by the observation obstruction specifying means 16. In the case that the observation obstruction specifying means 16 specifies an obstruction to observation within the first examination image 21, the corresponding position determining means 17 specifies a portion within the second examination image 22 corresponding to the obstruction to observation specified within the first examination image 21. The corresponding position determining means 17 employs the correspondent relationship between the two images generated by the positional aligning means 15 to specify the position or region within the second examination image 22 that corresponds to the obstruction to observation specified within the first examination image 21.

The corresponding position indicating means 17 indicates the portion corresponding to the specified obstruction to observation determined by the corresponding position determining means 17 within the second virtual endoscopy image generated from the second examination image 22. Indication of the portion that corresponds to the obstruction to observation may be performed by enhanced contrast, an annotation, or display of a warning. For example, the corresponding position indicating means 17 indicates the portion within the second virtual endoscopy image 32 displayed by the display apparatus 30 corresponding to the obstruction to observation, when the position or the region determined by the corresponding position determining means 17 is visualized. A user may confirm the state of the location, which is an obstruction to observation within the first virtual endoscopy image 31, within the second virtual endoscopy image 32, by observing the second virtual endoscopy image 32. Note that the corresponding position indicating means 17 indicates the portion which is specified as the obstruction to observation within the first virtual endoscopy image, generated from the first examination image 21 in which the obstruction to observation is specified.

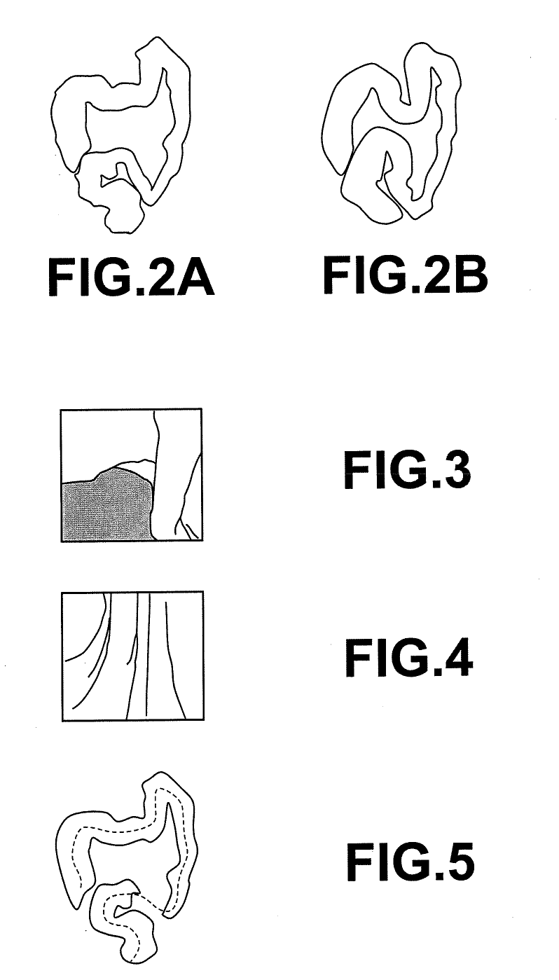

FIG. 2A and FIG. 2B are diagrams that illustrate examples of large intestine regions extracted from a first examination image 21 and a second examination image 22. The first examination image 21 (FIG. 2A) is an image obtained by imaging with a subject in the supine position, and the second examination image 22 (FIG. 2B) is an image obtained by imaging with the subject in the prone position. The large intestine in the two images is of the same person. However, because the bodily positions during imaging operations are different, the shape of the large intestine is different in the two images. The positional aligning means 15 extracts the large intestine region from each of the first and second examination images 21 and 22, performs non rigid registration with respect to the extracted large intestine regions, and correlates the two images in pixel units based on the results of registration, for example.

For example, the positional aligning means 15 generates pairs of the positions of pixels within the first examination image 21 and the positions of pixels within the second examination image 22 corresponding to these pixels as correspondent relationship information. Alternatively, the positional aligning means 15 may generate parameters for converting the positions of pixels within the first examination image 21 to the positions of pixels within the second examination image 22 corresponding thereto as correspondent relationship information. It is not necessary for the positions of pixels within the first examination image 21 and the positions of pixels within the second examination image 22 to be correlated on a one to one basis. A single pixel within the first examination image 21 may be correlated to a plurality of pixels within the second examination image 22.

As an alternative to the above configuration, the positional aligning means 15 may perform registration employing expanded view images, which are two dimensional images in which the inner walls of lumens are expanded. Expanded view images are images in which portions corresponding to the inner walls of lumens to be displayed in virtual endoscopy images are projected (mapped) onto two dimensional images as though the lumens are cut open. An expanded view image may be generated by the following steps, for example. First, a lumen which is to be visualized as a virtual endoscopy image is extracted from an examination image. The extracted lumen is extended in the direction of a center line thereof. Next, rays are extended in all directions (360 degrees) from the center line within each cross section of the lumen. When the rays pass through voxels that satisfy predetermined conditions, the voxels are projected onto a two dimensional image. Correspondent relationships among pixels within the first examination image 21 and pixels within the second examination image 22 can be obtained by aligning the expanded view images generated from the two examination images by the non rigid registration technique.

FIG. 3 is a diagram that illustrates an example of a virtual endoscopy image of the large intestine in which residue is visualized. In FIG. 3, the portion indicated as gray represents the residue. In the case that residue is pictured within a virtual endoscopy image, the inner wall of the large intestine behind the residue cannot be visualized. A user may observe the first virtual endoscopy image 31 displayed by the display apparatus 30 while moving the viewpoint position along the path, for example. When residue is confirmed within the first virtual endoscopy image 31, the user may mark the position or the region of the residue. The observation obstruction specifying means 16 specifies the position or the region of the pixel (voxel) within the first examination image 21 that corresponds to the position or the region within the virtual endoscopy image marked by the user as the position or the region of an obstruction to observation. In the case that residue is tagged in advance by a contrast agent, the observation obstruction specifying means 16 may automatically set observation obstructing regions by utilizing differences in CT values between residue, air, and body tissue to specify residue regions.

FIG. 4 is a diagram that illustrates an example of a virtual endoscopy image in which folds are concentrated on an inner wall of the large intestine. Such folds appear at the hepatic flexure and the splenic flexure, at which the direction of the large intestine changes greatly. If folds are concentrated on the inner wall of the large intestine, there is a possibility that polyps, etc., behind the folds will be overlooked. A user may observe the first virtual endoscopy image 31 displayed by the display apparatus 30 while moving the viewpoint position along the path, for example. When a location at which folds are concentrated is confirmed within the first virtual endoscopy image 31, the user may mark the position or the region of the concentrated folds. The observation obstruction specifying means 16 specifies the position or the region of the pixel (voxel) within the first examination image 21 that corresponds to the position or the region within the virtual endoscopy image marked by the user as the position or the region of an obstruction to observation. The observation obstruction specifying means 16 may automatically set observation obstructing regions by performing image analysis of the virtual endoscopy image to find locations where folds are concentrated. Alternatively, the observation obstruction specifying means 16 may calculate radii of curvature from the shape of the large intestine, and automatically set portions having radii of curvature greater than or equal to a predetermined threshold value as observation obstructing regions.

FIG. 5 is a diagram that illustrates a case in which an occlusion is present in an intestinal tract. The broken line in FIG. 5 denotes a path set within the large intestine. In the case that an occlusion is present in the large intestine, the interior of the occluded portion cannot be visualized by a virtual endoscopy image. A user may observe an image of the exterior of the large intestine extracted from the first examination image 21, for example, and may mark the position or the region of an occluded portion. The observation obstruction specifying means 16 specifies the position or the region of the pixel (voxel) within the first examination image 21 that corresponds to the position or the region marked by the user as the position or the region of an obstruction to observation. The observation obstruction specifying means 16 may automatically specify occlusions as observation obstructing regions by: extracting the large intestine region; measuring the diameters of the large intestine region when the large intestine region is cut at planes perpendicular to the path set therein; and judging that positions or regions at which the measured diameter of the large intestine region is less than or equal to a predetermined threshold value.

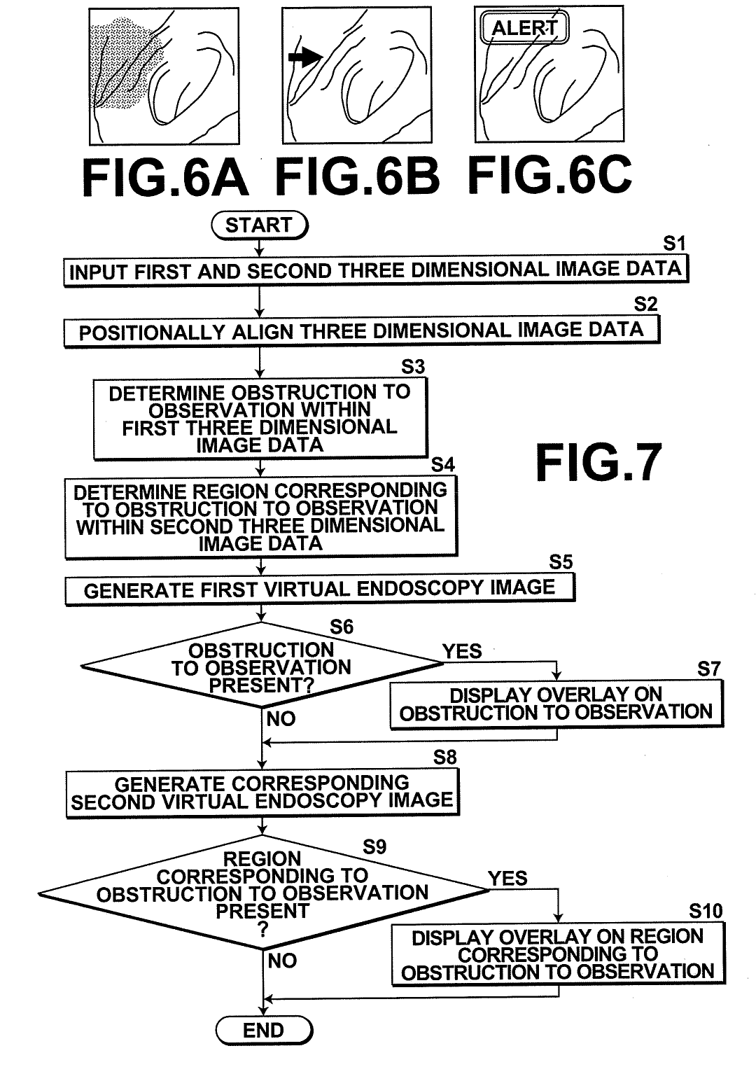

FIGS. 6A through 6C are diagrams that illustrate examples of methods by which portions corresponding to obstructions to observation are indicated. Even if the position or region of an obstruction to observation is specified within the first examination image 21, it is not always the case that the position or region corresponding thereto within the second examination image 22 is an obstruction to observation. When the position or region of the second examination image 22 determined by the corresponding position determining means 17 is visualized as the second virtual endoscopy image 32, the corresponding position indicating means 17 displays the position or region in a highlighted manner within the second virtual endoscopy image, as illustrated in FIG. 6A. The corresponding position indicating means 17 increases the contrast of the position or region corresponding to the obstruction to observation within the second virtual endoscopy image 32 to be higher than the contrast of other regions to indicate the contrast of the position or region corresponding to the obstruction to observation, for example. Attributes such as the type of obstruction may be imparted to the obstruction to observation, and information such as the type of obstruction may also be displayed when the position or region corresponding to the obstruction to observation is indicated.

Instead of the method of indication above, the corresponding position indicating means 17 may display a graphic such as an arrow overlaid on the second virtual endoscopy image to indicate the position or region corresponding to the obstruction to observation, as illustrated in FIG. 6B. In the case that a region, not a position, corresponding to the obstruction to observation is specified by the corresponding position determining means 17, the corresponding position indicating means 18 may display the arrow at the position of the barycenter of the region corresponding to the obstruction to observation. As a further alternative, the corresponding position indicating means 18 may display warning text or a graphic overlaid on the second virtual endoscopy image 32 as illustrated in FIG. 60, to notify a user that a position or a region corresponding to an obstruction to observation is being visualized in the second virtual endoscopy image 32. In all three cases, users can know that a portion corresponding to the obstruction to observation is being visualized in the second virtual endoscopy image. Whether disease that could not be confirmed within the first virtual endoscopy image is present can be judged employing the second virtual endoscopy image 32, by carefully observing the region corresponding to the obstruction to observation.

FIG. 7 is a flow chart that illustrates the operating procedures of the image processing apparatus 10. The examination image input means 11 inputs a first examination image 21 and a second examination image 22 (step S01). The first and second examination images 21 and 22 are two sets of three dimensional image data in which the position of the body is different during imaging operations, such as those obtained by supine/prone imaging. Alternatively, the first and second examination images 21 and 22 may be three dimensional image data of a single subject obtained at different times, for observation of disease progression. The path setting means 12 sets paths within the first and second examination images 21 and 22. The path setting means 12 sets the center lines of lumens as the paths, for example.

The positional aligning means 15 performs image registration with respect to the first and second examination images 21 and 22 (step S02). The positional aligning means 15 may employ the non rigid registration technique to correlate the entireties of the three dimensional image data or large intestine regions, which are extracted in advance, in pixel units. The positional aligning means 15 may alternatively employ a registration technique to correlate pixels of expanded view images of large intestine regions. The positional aligning means 15 generates correspondent relationship information that indicates the correspondent relationships among pixels.

The observation obstruction specifying means 16 specifies an observation obstructing region within one of the two examination images, for example, the first examination image 21 (step S03). The specification of the observation obstructing region may be performed automatically by the observation obstruction specifying means 16 analyzing the first examination image 21. Alternatively, a user may manually specify the observation obstructing region. The corresponding position determining means 17 specifies a region corresponding to the observation obstructing region specified within one of the examination images within the other of the examination images, for example, the second examination image 22, based on the results of registration at step S02 (step S04).

The virtual endoscopy image generating means 13 generates a first virtual endoscopy image based on the first examination image 21 (step S05). The virtual endoscopy image generating means 13 generates a virtual endoscopy image having a point along a first path set by the path setting means 12 as viewpoints. The corresponding position indicating means 18 judges whether the observation obstructing region specified in step S03 is being visualized within the virtual endoscopy image generated at step S5 (step S06). When the observation obstructing region is being visualized within the first virtual endoscopy image, the corresponding position indicating means 18 displays an overlay on the obstruction to observation within the first virtual endoscopy image (step S07). The overlay displayed on the obstruction to observation may be the same as those illustrated in FIGS. 6A through 6C.

The virtual endoscopy image generating means 13 generates a second virtual endoscopy image based on the second examination image 22 (step S08). At step S08, the virtual endoscopy image generating means 13 generates the second virtual endoscopy image having a viewpoint at a position corresponding to the viewpoint of the first virtual endoscopy image generated at step S05. The corresponding position indicating means 18 judges whether the region corresponding to the observation obstructing region specified in step S04 is being visualized within the virtual endoscopy image generated at step S8 (step S09). When the region corresponding to the observation obstructing region is being visualized within the second virtual endoscopy image, the corresponding position indicating means 18 displays an overlay on the region corresponding to the obstruction to observation within the second virtual endoscopy image (step S10).

The output means 14 simultaneously outputs the first virtual endoscopy image generated at step S5 and the second virtual endoscopy image generated at step S08 to the display apparatus, and causes the two virtual endoscopy images to be displayed on the display screen simultaneously. The obstruction to observation and the portion corresponding thereto are indicated in the first and second virtual endoscopy images which are displayed simultaneously. Therefore, a user can compare the two virtual endoscopy images to observe the state of a portion, which cannot be confirmed or is difficult to confirm in the first virtual endoscopy image, within the second virtual endoscopy image. As an alternative to displaying two virtual endoscopy images, generation of the first virtual endoscopy image may be omitted, and only the second virtual endoscopy image may be displayed on the display screen. In this case as well, a user can carefully observe a portion within the second virtual endoscopy image corresponding to a position or region which has been specified as an obstruction to observation within the first examination image 21.

In the first embodiment, an obstruction to observation is specified within one of a plurality of examination images, and a portion corresponding to the obstruction to observation is specified within an examination image in which the obstruction to observation has not been specified. The corresponding position indicating means 18 indicates the portion corresponding to the obstruction to observation within a virtual endoscopy image generated from the examination image in which the obstruction to observation has not been specified. This configuration enables users to know what portion corresponds to the portion specified as an obstruction to observation in one examination image when a different examination image is visualized. Users can confirm whether polyps, etc. that cannot be observed within the examination image in which the obstruction to observation was specified are present at portions corresponding to obstructions to observation by carefully observing these portions. Particularly, in the case that two virtual endoscopy images are displayed simultaneously by the display apparatus, users can easily specify the obstruction to observation within one virtual endoscopy image in the other virtual endoscopy image when observing the two virtual endoscopy images simultaneously. For this reason, the efficiency of image observation is improved, and shortening of the time required for diagnosis can be expected.

Note that in the foregoing description, a case has been described in which virtual endoscopy images are employed as observation images. However, observation images for visualizing the interiors of lumens may be images other than virtual endoscopy images. For example, an expanded view image generating means may be provided instead of or in addition to the virtual endoscopy image generating means, and expanded view images generated by the expanded view image generating means may be employed as the observation images. As another example, a straight view image generating means that generates straight view images, which are images that cut lumens along a predetermined plane to observe the interiors of the lumens from a direction perpendicular to the plane, may be employed, and straight view images may be employed as the observation images. In the case that expanded view images or straight view images are generated as the observation images, the corresponding position indicating means 18 may indicate the position or the region corresponding to an obstruction to observation within an expanded view image or a straight view image generated from an examination image in which the obstruction to observation was not specified.

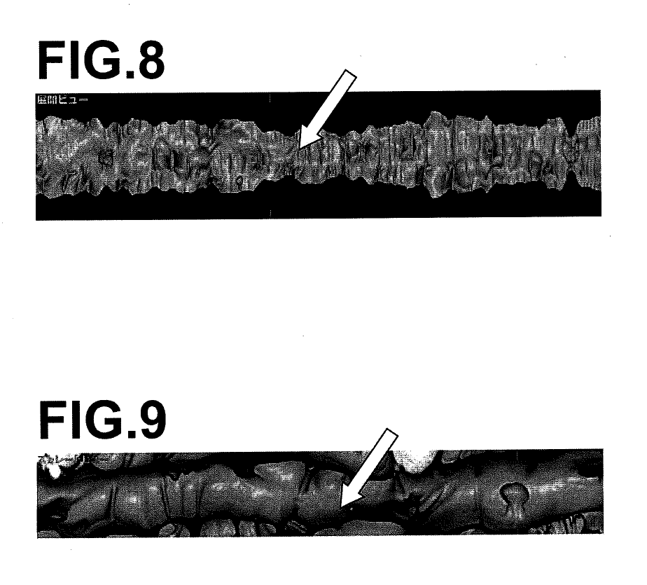

FIG. 8 illustrates an example of an expanded view image employed as an observation image. The corresponding position indicating means 18 displays an arrow or the like that indicates a position or a region corresponding to an obstruction to observation as an overlay on the expanded view image generated from an examination image in which the obstruction to observation was not specified, in the same manner as illustrated in FIG. 6B, for example. Alternatively, the contrast of the position or the region corresponding to the obstruction to observation within the expanded view image may be set higher than the contrast of other regions in the same manner as illustrated in FIG. 6A. In the case that a warning is displayed in the expanded view image, the warning may be displayed in the vicinity of the position or the region that corresponds to the obstruction to observation.

FIG. 9 is a diagram that illustrates an example of a straight view image employed as an observation image. In the case that the straight view image is employed as the observation image, an arrow or the like that indicates a position or a region corresponding to an obstruction to observation may be displayed as an overlay on the straight view image generated from an examination image in which the obstruction to observation was not specified, in the same manner as in the case of the expanded view image. Alternatively, the contrast of the position or the region corresponding to the obstruction to observation may be increased, or a warning may be displayed. Expanded view images and straight view images enable observation of the entire interior of the large intestine at once. Therefore, by indicating the position or the region corresponding to the obstruction to observation, great increases in image observation speed can be expected.

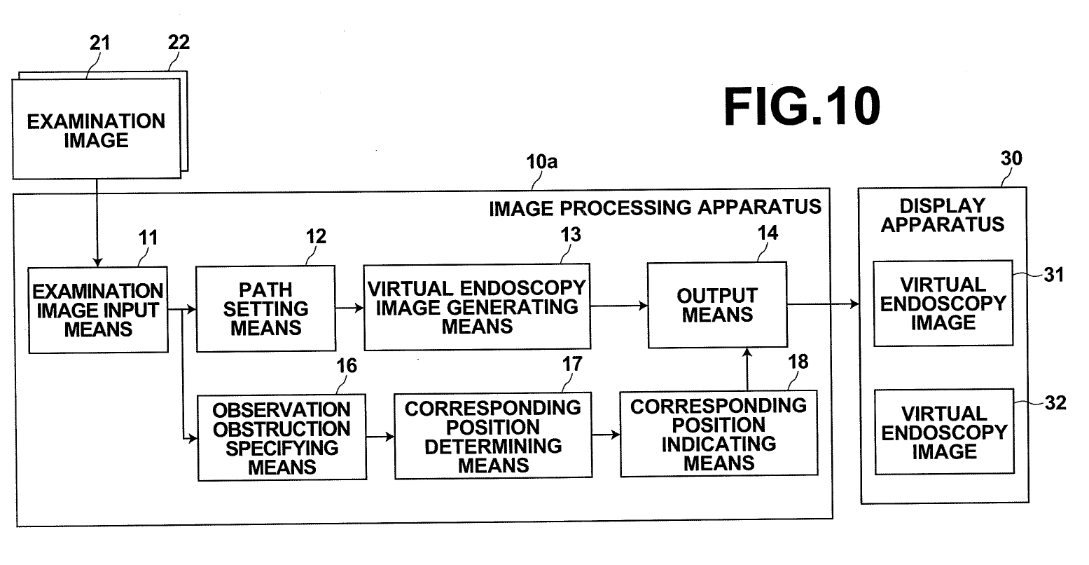

Next, a second embodiment of the present invention will be described. FIG. 10 illustrates an image processing apparatus 10a according to the second embodiment of the present invention. The configuration of the image processing apparatus 10a of the second embodiment is the same as the image processing apparatus of the first embodiment illustrated in FIG. 1, except that the positional aligning means 15 is omitted. The second embodiment employs positions along paths set by the path setting means 12 as the positions of obstructions to observations and positions corresponding thereto. The observation obstruction specifying means 16 specifies a position along a first path set within a first examination image 21 as the portion of the obstruction to observation. The corresponding position determining means 17 determines a position along a second path set within a second examination image 22 corresponding to the position along the first path set as the obstruction to observation, based on the correspondent relationship between the first path and the second path.

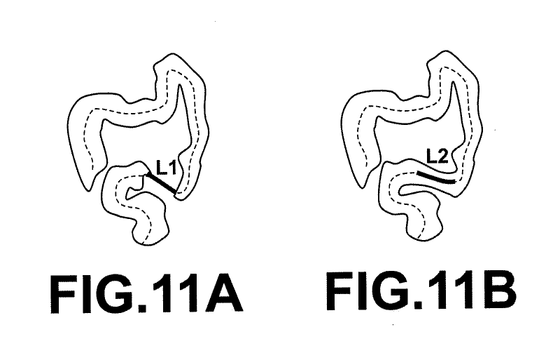

FIGS. 11A and 11B illustrate large intestine regions within the first and second examination images. In FIGS. 11A and 11B, the broken lines represent paths set within the large intestine. Referring to FIG. 11A, a portion of the intestinal tract is partially occluded in the first examination image 21. The observation obstruction specifying means 16 specifies a portion along the path (a range of the path) set by the path setting means 12 within the first examination image corresponding to the partially occluded intestinal tract as an observation obstructing section L1. The corresponding position determining means 17 obtains an observation obstruction corresponding section L2 within the second examination image 22 illustrated in FIG. 11B corresponding to the observation obstructing section L1. The relationship between the observation obstructing section L1 and the observation obstruction corresponding section L2 can be obtained easily by the image deformation method, correlations between the paths, etc.

IN the case that the obstruction to observation is residue, the observation obstruction specifying means 16 discriminates a residue region within the first examination image 21, extends lines normal to the path from the discriminated residue region, obtains the section of the path corresponding to the residue region, and specifies the obtained section as the observation obstructing section. In the case that the obstruction to observation is a curved portion, the section of the path that the curved portion corresponds to is obtained, and the obtained section is specified as the observation obstructing section.

When the virtual endoscopy image generating means 13 generates a second virtual endoscopy image having the position along the second path specified as the portion corresponding to the obstruction to observation as a viewpoint, the corresponding position indicating means 18 indicates the portion corresponding to the obstruction to observation in the second virtual endoscopy image. For example, when the virtual endoscopy image generating means 13 generates a virtual endoscopy image having a point within the observation obstruction corresponding section L2 illustrated in FIG. 11B along the second path, the corresponding position indicating means 18 indicates that this portion corresponds to the obstruction to observation in the second virtual endoscopy image.

A user can know that a portion corresponding to the obstruction to observation is being visualized in the second virtual endoscopy image. Whether disease that could not be confirmed within the first virtual endoscopy image is present can be judged employing the second virtual endoscopy image 32, by carefully observing the region corresponding to the obstruction to observation. There are cases in which pixels that represent the inner walls of lumens are not present within the first examination image 21 at occluded portions. Therefore, it is considered effective to specify obstructions to observation and positions corresponding thereto, when occlusions are considered as obstructions to observation.

In the second embodiment as well, expanded view images or straight view images may be employed as the observation images in the same manner as in the first embodiment. In the case that expanded view images or straight view images are employed as the observation images, the corresponding position indicating means 18 may indicate that portions specified as observation obstruction corresponding sections along the second path are portions that correspond to obstructions to observation. For example, the contrast of the portion corresponding to the observation obstruction corresponding section L2 illustrated in FIG. 11B in the expanded view image of FIG. 8 may be increased, to indicate what portion of the expanded view image is the portion corresponding to the obstruction to observation.

Note that in the embodiments described above, the obstruction to observation was specified in one of the first and second examination images 21 and 22, and the portion corresponding to the obstruction to observation was specified in the other of the first and second examination images 21 and 22. A configuration may be adopted, in which obstructions to observation are specified in both images. For example, portions corresponding to obstructions to observation specified in the first examination image 21 may be indicated in the second virtual endoscopy image generated from the second examination image 22, and portions corresponding to obstructions to observation specified in the second examination image 22 may be indicated in the first virtual endoscopy image generated from the first examination image 21. In this case, portions which are difficult to observe in the first virtual endoscopy image may be observed in the second virtual endoscopy image, and portions which are difficult to observe in the second virtual endoscopy image may be observed in the first virtual endoscopy image.

In addition, the number of examination images to be input into the image processing apparatus 10 is not limited to 2. Three or more examination images may be input into the image processing apparatus 10. For example, in the case that three examination images (a first through third examination images) are input into the image processing apparatus 10, the positional aligning means 15 may perform positional alignment between the first examination image and the second examination image, and also perform positional alignment between the first examination image and the third examination image. In addition, the corresponding position determining means 17 may determine positions or regions within both the second and third examination images corresponding to obstructions to observation specified in the first examination image. The corresponding position indicating means 18 may indicate positions corresponding to the obstruction to observation specified in the first examination image during observation of virtual endoscopy images based on the second and third examination images.

In the case that three or more examination images are input, obstructions to observation may be specified within at least one of the three or more examination images, and portions corresponding to the obstructions to observation may be determined within at least one of the remaining plurality of examination images. In this case, the portions corresponding to the obstructions to observation may be indicated in virtual endoscopy images generated from examination images in which the portions corresponding to the obstructions have been determined. For example, in the case that there are supine/prone examination images obtained one month previously and supine/prone examination images obtained currently, that is, a total of four examination images, obstructions to observation may be specified in one of the four examination images. Portions corresponding to the obstructions to observation may be determined within each of the remaining three examination images, and the portions corresponding to the obstructions to observation may be indicated in virtual endoscopy images generated from the three examination images.

The present invention has been described based on preferred embodiments. However, the image processing apparatus, the image processing method, and the image processing program of the present invention are not limited to the above embodiments. Various corrections and changes to the above embodiments are included within the scope of the present invention.

What is claimed is:

1. An image processing apparatus, comprising:
an observation obstruction specifying section that specifies an obstruction to observation in a first examination image, from among a plurality of examination images that represent the interior of a subject having a lumen imaged by a medical image obtaining apparatus;
a corresponding position determining section that specifies a portion within a second examination image, from among the plurality of examination images in which the obstruction to observation has not been specified, corresponding to the obstruction to observation specified within the first examination image;
an observation image generating section that generates a plurality of observation images that enable visualization of the interior of the lumen, from the plurality of examination images; and
a corresponding position indicating section that indicates the portion corresponding to the obstruction to observation specified by the corresponding position determining section within an observation image generated from the second examination image.

2. An image processing apparatus as defined in claim 1, wherein:
the observation obstruction specifying section specifies one of the position of a desired pixel and a region having a desired range within a region corresponding to the lumen in the first examination image as the portion of the obstruction to observation.

3. An image processing apparatus as defined in claim 2, further comprising:
a positional aligning section that generates correspondent relationships among pixels of at least the regions within the first and the second examination images that correspond to the lumen; and wherein:
the corresponding position determining section employs the generated correspondent relationships to specify one of the position and the region in the second examination image that corresponds to one of the position and the region specified in the first examination image as the portion that corresponds to the obstruction to observation.

4. An image processing apparatus as defined in claim 3, wherein:
the positional aligning section performs non rigid registration between the regions corresponding to the lumen in the first and second examination images, and generates the correspondent relationships based on the results of the positional alignment.

5. An image processing apparatus as defined in claim 3, wherein:
the observation image generating section generates a virtual endoscopy image that enables visualization of the interior of the lumen as a pseudo three dimensional image as the observation image;
the corresponding position indicating section indicates the portion corresponding to the specified obstruction to observation when the specified position or region in the second examination image is visualized in a virtual endoscopy image generated from the second examination image.

6. An image processing apparatus as defined in claim 3, wherein:
the observation image generating section generates at least one of an expanded view image, in which the lumen is extended linearly, a portion corresponding to the inner wall of the lumen is cut open and projected two dimensionally, and a straight view image, in which the lumen is cut at a predetermined plane and the lumen is viewed from a direction perpendicular to the plane, as an observation image; and
the corresponding position indicating section indicates the portion within the observation image corresponding to the position or region specified in the second examination image as the specified obstruction to observation.

7. An image processing apparatus as defined in claim 1, further comprising:
a path setting section that sets paths within the lumen in each of the first and second examination images; wherein:
the observation obstruction specifying section specifies a desired position along the path set within the lumen in the first examination image as the portion of the obstruction to observation; and
the corresponding position determining section determines a position along the path set within the lumen in the second examination image corresponding to a position along the path set within the lumen in the first examination image as the portion corresponding to the obstruction to observation, based on the correspondent relationship between the paths set within lumens in the first and second examination images.

8. An image processing apparatus as defined in claim 7, wherein:
the observation image generating section generates a virtual endoscopy image having a desired point along the set path as a viewpoint as the observation image; and
the corresponding position indicating section indicates a portion within the virtual endoscopy image corresponding to the specified obstruction to observation, when a virtual endoscopy image having a position specified as the portion corresponding to the obstruction to observation along the path set within the lumen in the second examination image as a viewpoint.

9. An image processing apparatus as defined in claim 7, wherein:
the observation image generating section generates at least one of an expanded view image, in which the lumen is extended linearly, a portion corresponding to the inner wall of the lumen is cut open and projected two dimensionally, and a straight view image, in which the lumen is cut at a predetermined plane and the lumen is viewed from a direction perpendicular to the plane, as an observation image; and
the corresponding position indicating section indicates the portion within the observation image at the position specified along the path set in the lumen within the second examination image as the portion corresponding to the specified obstruction to observation.

10. An image processing method, comprising:
specifying an obstruction to observation in a first examination image, from among a plurality of examination images that represent the interior of a subject having a lumen imaged by a medical image obtaining apparatus;
specifying a portion within a second examination image, from among the plurality of examination images in which the obstruction to observation has not been specified, corresponding to the obstruction to observation specified within the first examination image;
generating a plurality of observation images that enable visualization of the interior of the lumen, from the plurality of examination images; and
indicating the portion corresponding to the specified obstruction to observation within an observation image generated from the second examination image.

11. A non transitory computer readable medium having stored therein a program that causes at least one computer to execute the procedures of:
specifying an obstruction to observation in a first examination image, from among a plurality of examination images that represent the interior of a subject having a lumen imaged by a medical image obtaining apparatus;
specifying a portion within a second examination image, from among the plurality of examination images in which the obstruction to observation has not been specified, corresponding to the obstruction to observation specified within the first examination image;
generating a plurality of observation images that enable visualization of the interior of the lumen, from the plurality of examination images; and
indicating the portion corresponding to the specified obstruction to observation within an observation image generated from the second examination image.
